(19) United States
(12) Patent Application Publication
(10) Pub. No.: US 2015/0123964 A1
(43) Pub. Date: May 7, 2015

(54) ORGANIC LIGHT EMITTING DIODE DISPLAY AND DRIVING METHOD THEREOF

(71) Applicant: Samsung Display Co., Ltd., Yongin-city (KR)

(72) Inventors: Jae-Hoon LEE, Yongin-city (KR); Jae-Woo SONG, Yongin-city (KR)

(21) Appl. No.: 14/532,757

(22) Filed: Nov. 4, 2014

(30) Foreign Application Priority Data
Nov. 7, 2013 (KR) 10-2013-0134611

(51) Int. Cl. G09G 3/32; G09G 5/18

(52) U.S. Cl. CPC G09G 3/3266; G09G 5/18
USPC 345/213; 345/82

(57) ABSTRACT

An organic light emitting diode (OLED) display and driving method thereof are disclosed. One inventive aspect includes a plurality of pixels, a scan driver, first and second power generation unit and a data driver. The scan driver supplies a first scan signal to odd-numbered scan lines during a first period and a second scan signal to even-numbered scan lines during a second period. The first and second power generation units set the pixels in a non-emission state during at least one frame of the first and second periods. The data driver supplies a data signal to data lines synchronous to the first and second scan signal.

### CROSS-REFERENCE TO RELATED APPLICATIONS

This application claims priority to and the benefit of Korean Patent Application No. 10-2013-0134611, filed on Nov. 7, 2013, in the Korean Intellectual Property Office, the entire contents of which are incorporated herein by reference in their entirety.

### BACKGROUND

1. Field

Various aspects of the disclosed technology relate to an organic light emitting diode display and a driving method thereof with improved pixel luminance and gray scale.

2. Description of the Related Technology

With the development of information technologies, the importance of a display as a connection medium between information increases. Accordingly, flat panel displays (FPDs) such as a liquid crystal display (LCD), an organic light emitting diode (OLED) display and a plasma display panel (PDP) are increasingly used.

Among these FPDs, the OLED displays images using organic light emitting diodes that emit light through recombination of electrons and holes. The organic light emitting diode display has a fast response speed and is driven with low power consumption.

### SUMMARY OF CERTAIN INVENTIVE ASPECTS

Embodiments provide an organic light emitting diode display and a driving method thereof, which can improve display quality.

One aspect of the disclosed technology provides an organic light emitting diode display, including: pixels configured to control whether current is supplied from a first power source to a second power source via an organic light emitting diode, corresponding to a data signal, a scan driver configured to supply a scan signal to odd-numbered scan lines during a first period including a plurality of frames, and supply a scan signal to even-numbered scan lines during a second period including a plurality of frames, a second power generation unit configured to control the voltage of the second power source so that the pixels is set in a non-emission state during at least one frame among the frames included in the first and second periods, and a data driver configured to supply a data signal to data lines, corresponding to the scan signal.

Each of the first and second periods can include five frames.

The data driver can supply a left data signal of a first image during first and second frames of the first period, supply a right data signal of the first image during third and fourth frames of the first period, and supply a black data signal during a fifth frame of the first period. The data driver can supply a left data signal of a second image during first and second frames of the second period, supply a right data signal of the second image during third and fourth frames of the second period, and supply a black data signal during a fifth frame of the second period.

Light can be supplied the left side of first glasses during the first and second frames of the first period, and light can be supplied to the right side of the first glasses during the third and fourth frames of the first period.

Light can be supplied to the left side of second glasses during the first and second frames of the first period, and light can be supplied to the right side of the second glasses during the third and fourth frames of the second period.

The second power generation unit can supply a second power source having a high voltage so that the pixels do not emit light during the first, third and fifth frames of the first and second periods, and supply a second power source having a low voltage so that the pixels emit light during the second and fourth frames of the first and second periods.

The voltage value of the low voltage can be set so that light with a desired luminance is generated corresponding to a data during the second and fourth frames of the first and second periods.

The organic light emitting diode display can include a first power generator configured to generate the first power source. The first power generation unit can supply a first power source having a third voltage at which the pixels emit light during the first, third and fifth frames of the first and second periods, and supply a fourth voltage higher than the third voltage during the second and fourth frames of the first and second periods.

Each frame included in the first and second periods can include a plurality of subfields. The scan driver can supply a scan signal to the odd-numbered or even-numbered scan lines every subfield.

The data driver can supply a first data signal where the pixels emit light, corresponding to the scan signal, or a second data signal where the pixels do not emit light.

The first and second periods can be formed to alternate with each other.

A display unit including the pixels can be divided into upper and lower units. The scan driver can be configured with a first scan driver for driving scan lines formed in the upper unit, and a second scan driver for driving scan lines formed in the lower unit. The data driver can be configured with a first data driver for driving data lines formed in the upper unit, and a second driver for driving data lines formed in the lower unit.

The first and second scan drivers can progressively supply a scan signal to the odd-numbered or even-numbered scan lines.

Another aspect of the disclosed technology provides a method of driving an organic light emitting diode display, the method including: supplying a scan signal to odd-numbered scan lines during a plurality of frames included in a first period, supplying a left or right data signal of a first image to be synchronized with the scan signal supplied to the odd-numbered scan lines during the first period, supplying a scan signal to even-numbered scan lines during a plurality of frames included in a second period, and supplying left or right data signal of a second image to by synchronized with the scan signal to the even-numbered scan lines during the second period.

The first and second periods can be formed to alternate with each other.

Each of the first and second periods can include five frames.

The left data signal of the first image can be supplied during first and second frames of the first period, the right data signal of the first image can be supplied during third and fourth frames of the first period, and a black data signal can be supplied during a fifth frame of the first period. The left data signal of the second image can be supplied during first and second frames of the second period, the right data signal of the second image can be supplied during third and fourth frames of the second period, and a black data signal can be supplied during a fifth frame of the second period.

Pixels can be set in a non-emission state during the first, third and fifth frames of the first and second periods.

The pixels can be control whether current flowing a first power source to a second power source via an organic light emitting diode is supplied. The second power source can be set to a high voltage during the first, third and fifth frames of the first and second periods.

The first power source can be set to a third voltage at which the pixels emit light during the first, third and fifth frames of the first and second periods. The first power source can be set to a fourth voltage higher than the third voltage during the second and fourth frames of the first and second periods.

Light can be supplied the left side of first glasses during the first and second frames of the first period, and light can be supplied to the right side of the first glasses during the third and fourth frames of the first period.

Light can be supplied to the left side of second glasses during the first and second frames of the first period, and light can be supplied to the right side of the second glasses during the third and fourth frames of the second period.

Each frame included in the first and second periods can include a plurality of subfields.

The left and right data signals supplied during the first and second periods can control the emission or non-emission of the pixels.

### BRIEF DESCRIPTION OF THE DRAWINGS

Exemplary embodiments will now be described more fully hereinafter with reference to the accompanying drawings; however, they can be embodied in different forms and should not be construed as limited to the embodiments set forth herein. Rather, these embodiments are provided so that this disclosure will be thorough and complete, and will fully convey the scope of the exemplary embodiments to those skilled in the art.

In the drawing figures, dimensions can be exaggerated for clarity of illustration. It will be understood that when an element is referred to as being “between” two elements, it can be the only element between the two elements, or one or more intervening elements can also be present. Like reference numerals refer to like elements throughout.

FIG. 1 is a diagram illustrating an organic light emitting diode display according to an embodiment of the disclosed technology.

FIG. 2 is a circuit diagram illustrating a pixel according to an embodiment of the disclosed technology.

FIGS. 3A and 3B are diagrams illustrating an operating process of the organic light emitting diode display according to an embodiment of the disclosed technology.

FIG. 4 is a diagram illustrating a driving method according to an embodiment of the disclosed technology.

FIG. 5 is a diagram illustrating a driving method according to another embodiment of the disclosed technology.

FIG. 6 is a diagram illustrating an organic light emitting diode display according to another embodiment of the disclosed technology.

FIG. 7 is a diagram illustrating a driving method according to still another embodiment of the disclosed technology.

FIG. 8 is a diagram illustrating a driving method according to still another embodiment of the disclosed technology.

### DETAILED DESCRIPTION OF CERTAIN INVENTIVE EMBODIMENTS

Hereinafter, certain exemplary embodiments according to the disclosed technology will be described with reference to the accompanying drawings. Here, when a first element is described as being coupled to a second element, the first element can be not only directly coupled to the second element but can also be indirectly coupled to the second element via a third element. Further, some of the elements that are not essential to the complete understanding of the invention are omitted for clarity. Also, like reference numerals refer to like elements throughout.

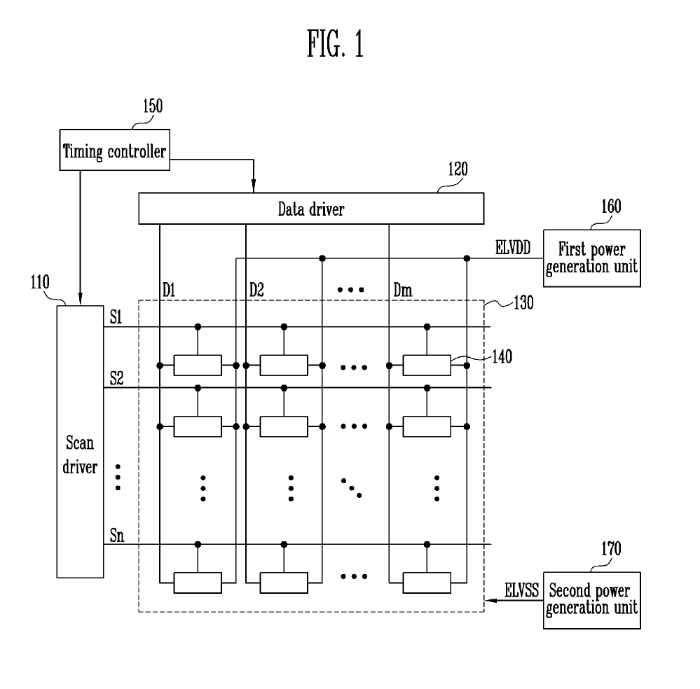

FIG. 1 is a diagram illustrating an organic light emitting diode display according to an embodiment of the disclosed technology. Hereinafter, it will be assumed that, for convenience of illustration, the organic light emitting diode display is driven using a dual view method in which different viewers watches two different 3D images displayed in a display unit 130.

Referring to FIG. 1, the organic light emitting diode display according to this embodiment includes the display unit 130, a scan driver 110, a data driver 120 and a timing controller 150. The display unit 130 is configured to include pixels 140, which are respectively formed at intersection portions of scan lines S1 to Sn and data lines D1 to Dm. The scan driver 110 is configured to drive the scan lines S1 to Sn. The data driver 120 is configured to drive the data lines D1 to Dm. The timing controller 150 is configured to control the scan driver 110 and the data driver 120.

The organic light emitting diode display according to this embodiment further includes a first power generation unit 160 and a second power generation unit 170. The first power generation unit 160 is configured to generate a first power source ELVDD. The second power generation unit 170 is configured to generate a second power source ELVSS.

The timing controller 150 controls the scan driver 110 and the data driver 120, corresponding to synchronization signals supplied from an outside thereof.

The scan driver 110 progressively supplies a scan signal to odd-numbered scan lines S1, S3, . . . during a first period including a plurality of frames. The scan driver 110 progressively supplies a scan signal to even-numbered scan lines S2, S4, . . . during a second period including a plurality of frames, which is linked to the first period. Here, each of the first and second periods includes the same number of frames and are repetitively formed to alternate with each other.

In one exemplary implementation, the first period is configured with five frames. A first image among images to be displayed in the display unit 130 is displayed during the first period. During the first period, a view wearing first glasses recognizes the first image as a 3D screen. The second period is configured with five frames, and a second image among the images to be displayed in the display unit 130 is displayed during the second period. During the second period, a view wearing second glasses recognizes the second image as a 3D screen.

The data driver 120 generates a data signal, corresponding to a data supplied from the timing controller 150, and supplies the generated data signal to the data lines D1 to Dm. Here, the data driver 120 supplies left and right data signals of the first image during the first period, and supplies left and right data signals of the second image during the second period.

Meanwhile, the left and right data signals supplied from the data driver 120 are set to a voltage at which the emission or non-emission of the pixels 140 is controlled. That is, the data driver 120 supplies, as the left and right data signals, first data signals where the pixels emit light or second data signals where the pixels does not emit light. In this case, the pixels 140 is driven using a digital driving method in which a gray scale is expressed corresponding to an emission time thereof.

The display unit 130 receives first and second power sources ELVDD and ELVSS supplied from an outside thereof. The display unit 130 supplies the received first and second power sources ELVDD and ELVSS to each pixel 140. Each pixel 140 implements a predetermined gray scale while supplying current of an organic light emitting diode (emitting light), corresponding to a data signal, or not supplying the current (not emitting light). The pixels 140 can be implemented with various types of circuits driven using the digital driving method, which are currently known in the art.

The first power generation unit 160 supplies the voltage of the first power source ELVDD, at which the pixels 140 can emit light during the first and second periods.

The second power generation unit 170 controls the voltage of the second power source ELVSS so that the pixels 140 do not emit light during some frames of the first and second periods. This will be described in detail later.

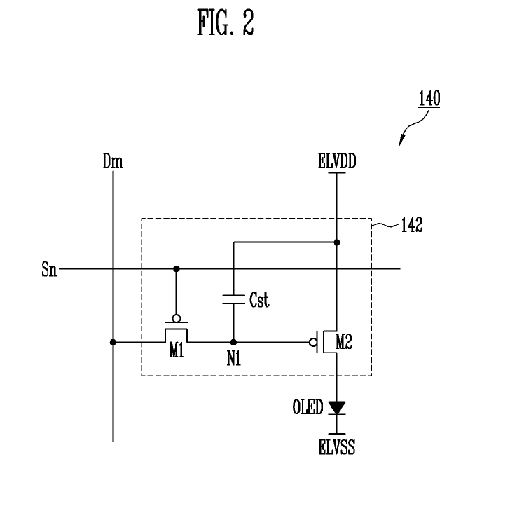

FIG. 2 is a circuit diagram illustrating a pixel according to an embodiment of the disclosed technology. For convenience of illustration, a pixel 140 formed on an n-th horizontal line and an m-th vertical line will be shown in FIG. 2.

Referring to FIG. 2, the pixel 140 according to this embodiment includes an organic light emitting diode OLED and a pixel circuit 142. The pixel circuit 142 is coupled to a data line Dm and a scan line Sn to control the organic light emitting diode OLED.

An anode electrode of the organic light emitting diode OLED is coupled to the pixel circuit 142. A cathode electrode of the organic light emitting diode OLED is coupled to the second power source ELVSS. The organic light emitting diode OLED is set in an emission state when current is supplied to the pixel circuit 142. The organic light emitting diode OLED is set in a non-emission state when the current is not supplied.

The pixel circuit 142 receives a data signal from the data line Dm when a scan signal is supplied to the scan line Sn. To this end, the pixel circuit 142 includes a first transistor M1, a second transistor M2 and a storage capacitor Cst.

A first electrode of the first transistor M1 is coupled to the data line Dm, and a second electrode of the first transistor M1 is coupled to a first node N1. A gate electrode of the first transistor M1 is coupled to the scan line Sn. When the scan signal is supplied to the scan line Sn, the first transistor M1 is turned on to allow the data line Dm and the first node N1 to be electrically coupled to each other. If the first transistor M1 is turned on, the data signal from the data line Dm is supplied to the first node N1.

The storage capacitor Cst is coupled between the first power source ELVDD and the first node N1. The storage capacitor Cst stores a voltage corresponding to the data signal.

A first electrode of the second transistor M2 is coupled to the first power source ELVDD. A second electrode of the second transistor M2 is coupled to the anode electrode of the organic light emitting diode OLED. A gate electrode of the second transistor M2 is coupled to the first node N1. The second transistor M2 is turned on or turned off corresponding to the voltage of the data signal, stored in the storage capacitor Cst.

If the second transistor M2 is turned on, current is supplied to the organic light emitting diode OLED during a corresponding period, and accordingly, the pixel 140 is set in the emission state. If the second transistor M2 is turned off, the current is not supplied to the organic light emitting diode OLED during a corresponding period, and accordingly, the pixel 140 is set in the non-emission state.

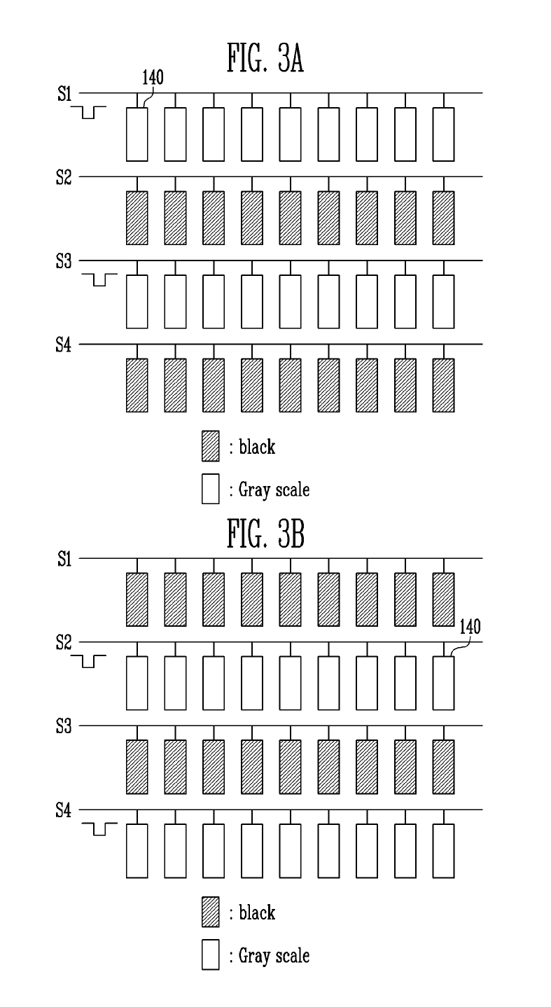

FIGS. 3A and 3B are diagrams illustrating an operating process of the organic light emitting diode display according to an embodiment of the disclosed technology.

Referring to FIGS. 3A and 3B, a scan signal is first supplied to the odd-numbered scan lines S1, S3, . . . during the first period as shown in FIG. 3A. Accordingly, pixels 140 formed on odd-numbered horizontal lines emit light, corresponding to a data. On the other hand, the pixels 140 coupled to the even-numbered scan lines S2, S4, . . . maintain the non-emission state (i.e., the black state), corresponding to the data signal (second data signal) supplied in a previous second period.

If the scan signal is supplied to only the odd-numbered scan lines S1, S3, . . . during the first period as described above, i.e., if the scan signal is supplied to half of the pixels 140 included in the display unit 130, it is possible to sufficiently secure a charging time of the pixels 140.

As shown in FIG. 3B, the scan signal is supplied to the even-numbered scan lines S2, S4, . . . during the second period, and accordingly, the pixels 140 formed on even-numbered horizontal lines emit light, corresponding to a data. On the other hand, the pixels 140 coupled to the odd-numbered scan lines S1, S3, . . . maintains the non-emission state (i.e., the black state) state, corresponding to the data signal (i.e., the second data signal) supplied in a previous first period.

If the scan signal is supplied to only the even-numbered scan lines S2, S4, . . . during the second period as described above, i.e., if the scan signal is supplied to half of the pixels 140 included in the display unit 130, it is possible to sufficiently secure a charging time of the pixels 140.

Additionally, the scan signal is supplied to the odd-numbered scan lines S1, S3, . . . during the first period. Hence a data signal of a desired gray scale is not supplied to the even-numbered scan lines S2, S4, . . . . That is, half of the data in one frame is not displayed as an image. However, data supplied to adjacent horizontal lines are identical or similar to each other. Hence, a desired image can be displayed even though a gray scale is implemented in only the pixels 140 coupled to the odd-numbered scan lines S1, S3, . . . .

Similarly, the scan signal is supplied to the even-numbered scan lines S2, S4, . . . during the second period. Hence, a data signal of a desired gray scale is not supplied to the odd-numbered scan lines S1, S3, . . . . That is, half of the data in the one frame is not displayed as an image. However, data supplied to adjacent horizontal lines are identical or similar to each other. Hence, a desired image can be displayed even though a gray scale is implemented in only the pixels 140 coupled to the even-numbered scan lines S2, S4, . . . .

Actually, the organic light emitting diode display of the disclosed technology is implemented using the dual view method. Although some data are not displayed during the first and second periods, the first and second images can be implemented. Additionally, if the even-numbered horizontal lines are implemented with the black in the disclosed technology, it is possible to implement more lifelike 3D images (to minimize false contour noise, or the like).

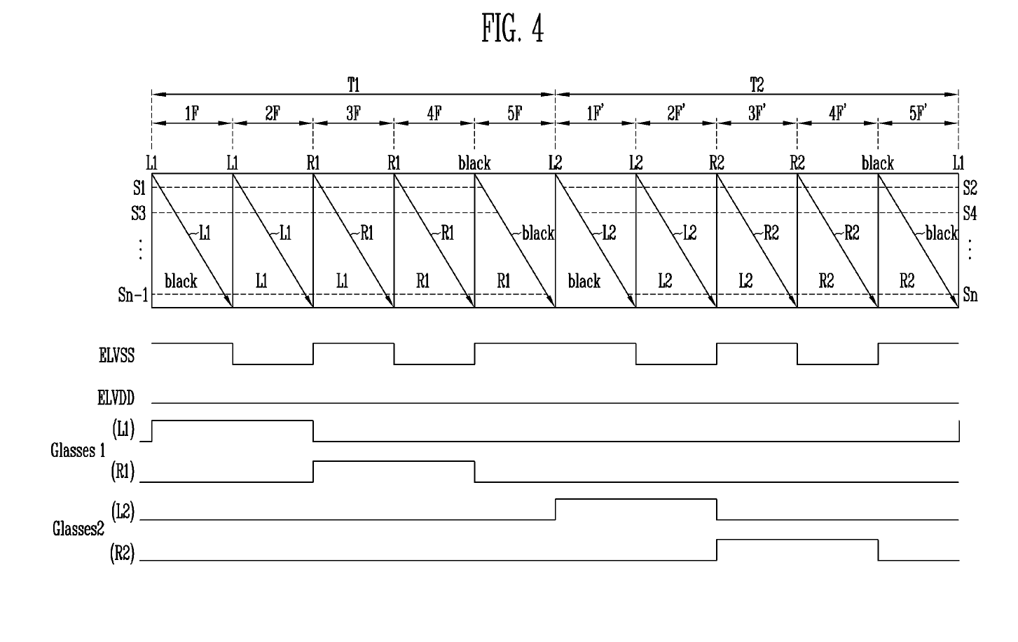

FIG. 4 is a diagram illustrating a driving method according to an embodiment of the disclosed technology.

Referring to FIG. 4, the first period T1 is configured with five frames 1F to 5F. The second period T2 is configured with five frames 1F′ to 5F′.

A scan signal is progressively supplied to the odd-numbered scan lines S1, S3, . . . during each frame included in the first period T1. Data signals are supplied to the data lines D1 to Dm, corresponding to the scan signal. The pixels 140 formed on the even-numbered horizontal lines are set in the black (non-emission) state during the first period T1.

A scan signal is progressively supplied to the odd-numbered scan lines S1, S3, . . . during a first frame 1F included in the first period T1 and a left data signal L1 of the first image is progressively supplied corresponding to the scan signal. Here, the scan signal is progressively supplied and hence the pixels 140 formed on the odd-numbered horizontal lines store the left data signal L1 of the first image or the black data signal, corresponding to the positions thereof. Thus, the second power source ELVSS is set to a high voltage so that an undesired image is not displayed during the first frame 1F. If the second power source ELVSS is set to the high voltage, the pixels 140 are set in the non-emission state.

A scan signal is progressively supplied to the odd-numbered scan lines S1, S3, . . . during a second frame 2F included in the first period T1, and the left data signal L1 of the first image is progressively supplied corresponding to the scan signal. Here, only the left data signal L1 of the first image is stored in the pixels 140 formed on the odd-numbered horizontal lines during the second frame period 2F. Thus, the second power source ELVSS is set to a low voltage during the second frame 2F. Accordingly, the pixels 140 formed on the odd-numbered horizontal lines emit light, corresponding to the left data signal L1 of the first image during the second frame 2F. Additionally, the left data signal L1 of the first image supplied during the second frame 2F can be set as a signal identical to the left data signal L1 of the first image supplied during the first frame 1F.

A scan signal is progressively supplied to the odd-numbered scan lines S1, S3, . . . during a third frame 3F included in the first period T1. A right data signal R1 of the first image is progressively supplied corresponding to the scan signal. Here, the scan signal is progressively supplied. Hence, the left and right data signals L1 and R1 of the first image are mixed in the third frame 3F. Thus, the second power source ELVSS is set to the high voltage so that an undesired image is not displayed during the third frame 3F.

A scan signal is progressively supplied to the odd-numbered scan lines S1, S3, . . . during a fourth frame 4F included in the first period T1. The right data signal R1 of the first image is progressively supplied corresponding to the scan signal. Here, only the right data signal R1 of the first image is stored in the pixels 140 formed on the odd-numbered horizontal lines in the fourth frame 4F. Thus, the second power source ELVSS is set to the low voltage during the fourth frame 4F. Accordingly, the pixels 140 formed on the odd-numbered horizontal lines emit light, corresponding to the right data signal R1 of the first image during the fourth frame 4F. Additionally, the right data signal R1 of the first image supplied during the fourth frame 4F can be set as a signal identical to the right data signal R1 of the first image supplied during the third frame 3F.

A scan signal is progressively supplied to the odd-numbered scan lines S1, S3, . . . during a fifth frame 5F included in the first period T1. The black data signal (i.e., the second data signal) is supplied corresponding to the scan signal. Then, the black data signal is progressively supplied to the pixels 140 coupled to the odd-numbered scan lines S1, S3, . . . .

Meanwhile, light is supplied to the left side of the first glasses during the first and second frames 1F and 2F of the first period T1, and light is supplied to the right side of the first glasses during the third and fourth frames 3F and 4F of the first period T1. Then, the viewer wearing the first glasses recognizes the first image as a 3D screen.

Additionally, in the disclosed technology, the pixels 140 emit light in only the second and fourth frames 2F and 4F among the consecutive five frames. Thus, the first image with a luminance lower than that to be implemented can be displayed. In the disclosed technology, in order to overcome such a disadvantage, the low voltage of the second power source ELVSS is controlled so that an image of a desired gray scale (luminance) can be implemented during the second and fourth frames 2F and 4F. In one exemplary implementation, the second power generation unit 170 controls the low voltage of the second power source ELVSS to have a voltage less than a generally supplied voltage. Therefore, the desired luminance can be implemented corresponding to a data.

Meanwhile, although it has been illustrated that, for convenience of illustration, the scan signal is supplied to the odd-numbered scan lines S1, S3, . . . every frame of the first period T1, the disclosed technology is not limited thereto. Actually, the pixels 140 of the disclosed technology are driven using the digital driving method. Accordingly, each frame 1F to 5F can be divided into a plurality of subfields so that a gray scale is implemented. In this case, a scan signal is supplied to the odd-numbered scan lines S1, S3, . . . every subfield and a data signal corresponding to the scan signal is supplied. Actually, the pixels 140 of the disclosed technology can be driven using various forms of digital driving methods currently known in the art.

A scan signal is progressively supplied to the even-numbered scan lines S2, S4, . . . during each frame included in the second period T2. Data signals are supplied to the data lines D1 to Dm, corresponding to the scan signal. During the second period 2T, the pixels 140 formed on the odd-numbered horizontal lines are set in the black state, corresponding to the data signal supplied in the previous period.

A scan signal is progressively supplied to the even-numbered scan lines S2, S4, . . . during a first frame 1F′ included in the second period T2. A left data signal L2 of the second image is progressively supplied corresponding to the scan signal. Here, the scan signal is progressively supplied. Hence, the pixels 140 formed on the even-numbered horizontal lines store the left data signal L2 of the second image or the black data signal, corresponding to the positions thereof. Thus, the second power source ELVSS is set to the high voltage so that an undesired image is not displayed during the first frame 1F′.

A scan signal is progressively supplied to the even-numbered scan lines S2, S4, . . . during a second frame 2F′ included in the second period T2. The left data signal L2 of the second image is progressively supplied corresponding to the scan signal. Here, only the left data signal L2 of the second image is stored in the pixels 140 formed on the even-numbered horizontal lines in the second frame 2F′. The second power source ELVSS is set to the low voltage in the second frame 2F′. Accordingly, the pixels 140 formed on the even-numbered horizontal lines emit light, corresponding to the left data signal L2 of the second image during the second frame 2F′. Additionally, the left data signal L2 of the second image supplied during the second frame 2F′ can be set as a signal identical to the left data signal L2 of the second image supplied to the first frame 1F′.

A scan signal is progressively supplied to the even-numbered scan lines S2, S4, . . . during a third frame 3F′ included in the second period T2. A right data signal R2 of the second image is progressively supplied corresponding to the scan signal. Here, the scan signal is progressively supplied. Hence, the left and right data signals L2 and R2 of the second image are mixed during the third frame 3F′. Thus, the second power source ELVSS is set to the high voltage so that an undesired image is not displayed during the third frame 3F′.

A scan signal is progressively supplied to the even-numbered scan lines S2, S4, . . . during a fourth frame 4F′ included in the second period T2. The right data signal R2 of the second image is progressively supplied corresponding to the scan signal. Here, only the right data signal R2 of the second image is stored in the pixels 140 formed on the even-numbered horizontal lines during the fourth frame 4F′. The second power source ELVSS is set to the low voltage in the fourth frame 4F′. Accordingly, the pixels 140 formed on the even-numbered horizontal lines emit light, corresponding to the right data signal R2 of the second image during the fourth frame 4F′. Additionally, the right data signal R2 of the second image supplied during the fourth frame 4F′ can be set as a signal identical to the right data signal R2 of the second image supplied during the third frame 3F′.

A scan signal is progressively supplied to the even-numbered scan lines S2, S4, . . . during a fifth frame 5F′ included in the second period T2. The black data signal is supplied corresponding to the scan signal. Then, the black data signal is supplied to the pixels 140 coupled to the even-numbered scan lines S2, S4, . . . .

Meanwhile, light is supplied to the left side of the second glasses in the first and second frames 1F′ and 2F′ of the second period T2, and light is supplied to the right side of the second glasses in the third and fourth frames 3F′ and 4F′. Then, the viewer wearing the second glasses recognizes the second image as a 3D screen. Actually, in the disclosed technology, 3D images are implemented by repeating the first and second periods T1 and T2 described above.

Additionally, in the disclosed technology, the second power generation unit 170 controls the low voltage of the second power source ELVSS to have a voltage lower than that generally supplied during the second and fourth frames 2F′ and 4F′, so that a desired luminance can be implemented corresponding to a data.

Meanwhile, although it has been illustrated in FIG. 4 that, for convenience of illustration, the scan signal is supplied to the even-numbered scan lines S2, S4, . . . every frame of the second period T2, the disclosed technology is not limited thereto. Actually, the pixels 140 of the disclosed technology are implemented using the digital driving method. Accordingly, each frame 1F′ to 5F′ can be divided into a plurality of subfields so that a gray scale is implemented. In this case, a scan signal is supplied to the even-numbered scan lines S2, S4, . . . every subfield. A data signal corresponding to the scan signal is supplied. Actually, the pixels 140 of the disclosed technology can be driven using various forms of digital driving methods current known in the art.

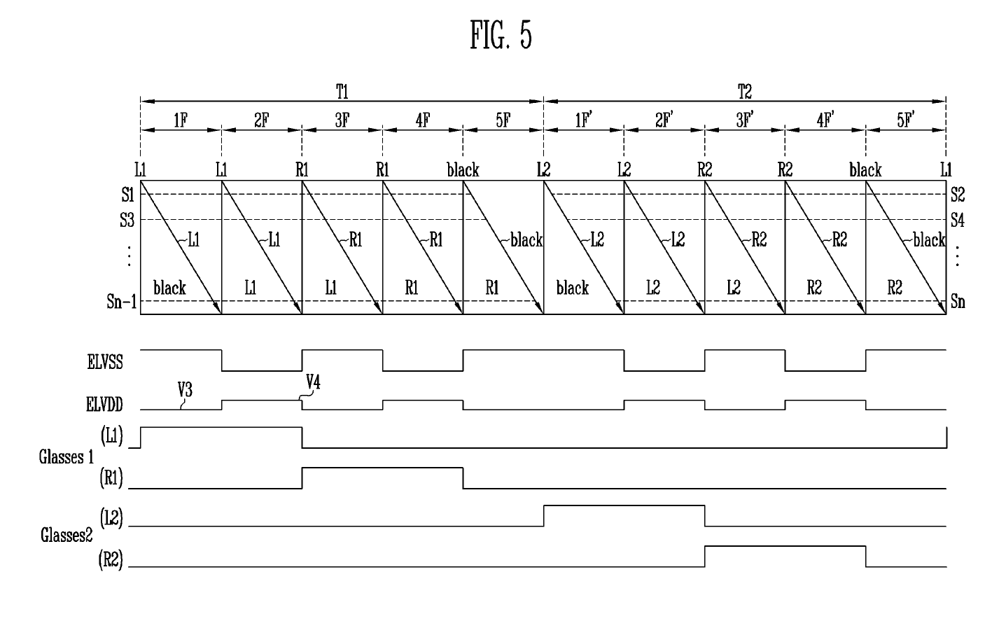

FIG. 5 is a diagram illustrating a driving method according to another embodiment of the disclosed technology. In FIG. 5, components identical to those of FIG. 4 are designated by like reference numerals, and their detailed descriptions will be omitted.

Referring to FIG. 5, in this embodiment, the voltage of the first power source ELVDD is controlled. Specifically, the first power generation unit 160 supplies a first power source ELVDD set to a third voltage V3 during the first frame 1F or 1F′, the third frame 3F or 3F′ and the fifth frame 5F or 5F′, in which the pixels 140 are set in the non-emission state, and supplies a first power source ELVDD set to a fourth voltage V4 higher than the third voltage V3 during the second frame 2F or 2F′ and the fourth frame 4F or 4F′, in which the pixels 140 are set in the emission state.

Here, the third voltage V3 is set as a voltage at which the pixels 140 can generally emit light in the digital driving method. Thus, the pixels 140 can stably store the voltage of a desired data signal during the first frame 1F or 1F′, the third frame 3F or 3F′ and the fifth frame 5F or 5F′, in which the pixels 140 are set in the non-emission state. The fourth voltage V4 is set as a voltage higher than the third voltage V3.

If the fourth voltage V4 higher than the third voltage V3 is supplied during the second frame 2F or 2F′ and the fourth frame 4F or 4F′, in which the pixels 140 emit light, the luminance of the pixels 140 is improved.

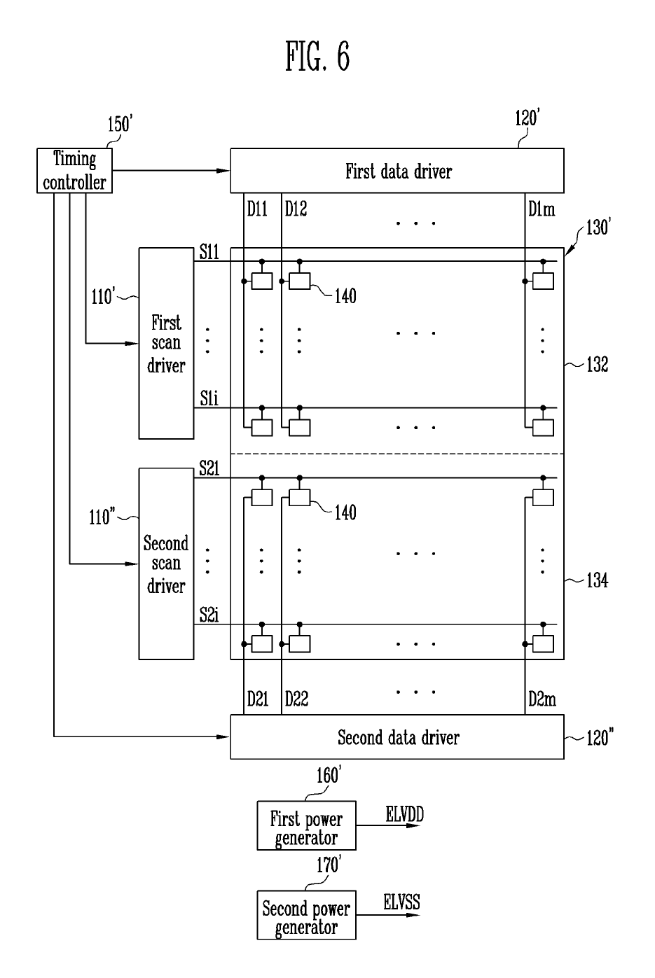

Meanwhile, in the aforementioned embodiment, the charging time has been secured by driving the odd-numbered or even-numbered scan lines. However, in this embodiment, a display unit 130′ is divided into upper and lower units 132 and 134 to be driven as shown in FIG. 6, so that it is possible to additionally a charging time of the pixels 140.

FIG. 6 is a diagram illustrating an organic light emitting diode display according to another embodiment of the disclosed technology. The substantial operation process of the organic light emitting diode display of FIG. 6 is identical to that of the organic light emitting diode display according to the embodiment shown in FIG. 1, except that the display unit 130′ is divided into sub-units to be driven.

Referring to FIG. 6, in the organic light emitting diode display, the display unit 130′ is divided into the upper and lower units 132 and 134 to be driven.

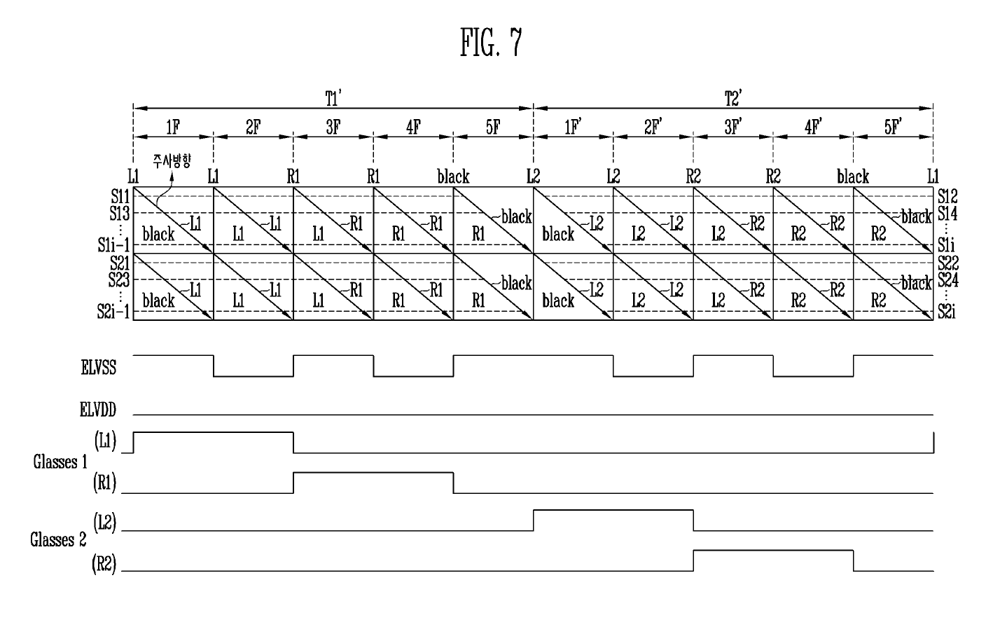

A first scan driver 110′ supplied a scan signal to scan lines S11 to S1i formed in the upper unit 132. In one exemplary implementation, the first driver 110′ progressively supplies a scan signal to odd-numbered scan lines S11, S13, . . . formed in the upper unit 132 during a first period T1′ shown in FIG. 7. The first scan driver 110′ progressively supplies a scan signal to even-numbered scan lines S22, S24, . . . formed in the upper unit 132 during a second period T2′.

A second scan driver 110″ supplies a scan signal to scan lines S21 to S2i formed in the lower unit 134. In one exemplary implementation, the second scan driver 110″ progressively supplies a scan signal to odd-numbered scan lines S21, S23, . . . formed in the lower unit 134 during the first period T1′. The second scan driver 110″ progressively supplies a scan signal to even-numbered scan lines S22, S24, . . . formed in the lower unit 134 during the second period T2′.

A first data driver 120′ generates a data signal, corresponding to a data supplied from a timing controller 150′, and supplies the generated data signal to data lines D11 to D1m formed in the upper unit 132. Here, the first data driver 120′ supplies the left and right data signals of the first image during the first period T1′ and supplies the left and right data signals of the second image during the second period T2′.

A second data driver 120″ generates a data signal, corresponding to a data supplied from the timing controller 150′, and supplies the generated data to data lines D21 to D2m formed in the lower unit 134. Here, the second data driver 120″ supplies the left and right data signals of the first image during the first period T1′ and supplies the left and right data signals of the second image during the second period T2′.

The display unit 130′ receives first and second power sources ELVDD and ELVSS supplied from an outside thereof, and supplies the received first and second power sources ELVDD and ELVSS to each pixel 140. Each pixel 140 implements a predetermined gray scale while supplying current of an organic light emitting diode (emitting light), corresponding to a data signal, or not supplying the current (not emitting light).

The timing controller 150′ controls the scan drivers 110′ and 110″ and the data drivers 120′ and 120″, corresponding to a synchronization signal supplied from an outside thereof.

A first power generation unit 160′ supplies the voltage of the first power source ELVDD, at which the pixels 140 can emit light during the first and second periods.

A second power generation unit 170′ controls the voltage of the second power source ELVSS so that the pixels 140 do not emit light during some frames of the first and second periods.

FIG. 7 is a diagram illustrating a driving method according to still another embodiment of the disclosed technology.

Referring to FIG. 7, the first period T1′ is configured with five frames 1F to 5F, and the second period T2′ is configured to five frames 1F′ to 5F′.

During a first frame 1F of the first period T1′, a scan signal is progressively supplied to the odd-numbered scan lines S11, S13, . . . and S21, S23, . . . formed in the upper and lower units 132 and 134, and the left data signal L1 of the first image is supplied to the data lines D11 to D1m and D21 to D2m formed in the upper and lower units 132 and 134, corresponding to the scan signal. In this case, the pixels formed on the odd-numbered horizontal lines store the left data signal L1 of the first image or the black data signal, corresponding to the positions thereof. Thus, the second power source ELVSS is set to the high voltage so that an undesired image is not displayed during the first frame 1F.

During a second frame 2F of the first period T1′, a scan signal is progressively supplied to the odd-numbered scan lines S11, S13, . . . and S21, S23, . . . , and the left data signal L1 of the first image is supplied to the data lines D11 to D1m and D21 to D2m formed in the upper and lower units 132 and 134, corresponding to the scan signal. The second power source ELVSS is set to the low voltage during the second frame 2F, and accordingly, the pixels 140 formed on the odd-numbered horizontal lines emit light, corresponding to the left data signal L1 of the first image during the second frame 2F.

During a third frame 3F of the first period T1′, a scan signal is progressively supplied to the odd-numbered scan lines S11, S13, . . . and S21, S23, . . . , and the right data signal R1 of the first image is supplied to the data lines D11 to D1m and D21 to D2m formed in the upper and lower units 132 and 134, corresponding to the scan signal. Here, during the third frame 3F, the pixels formed on the odd-numbered horizontal lines store the left or right data signal L1 or R1 of the first image, corresponding to the positions thereof. Thus, the second power source ELVSS is set to the high voltage so that an undesired image is not displayed during the third frame 3F.

During a fourth frame 4F of the first period T1′, a scan signal is progressively supplied to the odd-numbered scan lines S11, S13, . . . and S21, S23, . . . , and the right data signal R1 of the first image is supplied to the data lines D11 to D1m and D21 to D2m formed in the upper and lower units 132 and 134, corresponding to the scan signal. The second power source ELVSS is set to the low voltage during the fourth frame 4F, and accordingly, the pixels 140 formed on the odd-numbered horizontal lines emit light, corresponding to the right data signal R1 of the first image during the fourth frame 4F.

During a fifth frame 5F of the first period T1′, a scan signal is progressively supplied to the odd-numbered scan lines S11, S13, . . . and S21, S23, . . . , and the black data signal is supplied to the data lines D11 to D1m and D21 to D2m formed in the upper and lower units 132 and 134, corresponding to the scan signal. Then, the black data signal is progressively supplied to the pixels 140 formed on the odd-numbered horizontal lines.

Meanwhile, light is supplied to the right side of the first glasses in the first and second frames 1F and 2F of the first period T1′ and light is supplied to the right side of the first glasses in the third and fourth frames 3F and 4F of the first period T1′. Then, the viewer wearing the first glasses recognizes the first image as a 3D screen.

Additionally, in the disclosed technology, the pixels 140 emit light in only the second and fourth frames 2F and 4F among the consecutive five frames. Thus, the first image with a luminance lower than that to be implemented can be displayed. In the disclosed technology, in order to overcome such a disadvantage, the low voltage of the second power source ELVSS is controlled so that an image of a desired gray scale (luminance) can be implemented during the second and fourth frames 2F and 4F. In one exemplary implementation, the second power generation unit 170′ controls the low voltage of the second power source ELVSS to have a voltage lower than a generally supplied voltage, so that the desired luminance can be implemented corresponding to a data.

Meanwhile, the pixels 140 of the disclosed technology are driven using the digital driving method. Accordingly, each frame 1F to 5F can be divided into a plurality of subfields so that a gray scale is implemented. In this case, a scan signal is supplied to the odd-numbered scan lines S11, S13, . . . and S21, S23, . . . every subfield, and a data signal corresponding to the scan signal is supplied. Actually, the organic light emitting diode display of the disclosed technology can be driven using various forms of digital driving methods currently known in the art.

During a first frame 1F′ of the second period T2′, a scan signal is progressively supplied to the even-numbered scan lines S12, S14, . . . and S22, S24, . . . formed in the upper and lower units 132 and 134, and the left data signal L2 of the second image is supplied to the data lines D11 to D1m and D21 to D2m formed in the upper and lower units 132 and 134, corresponding to the scan signal. In this case, the pixels 140 formed on the even-numbered horizontal lines store the left data signal L2 of the second image or the black data signal, corresponding to the positions thereof. Thus, the second power source ELVSS is set to the high voltage so that an undesired image is not displayed during the first frame 1F′.

During a second frame 2F′ of the second period T2′, a scan signal is progressively supplied to the even-numbered scan lines S12, S14, . . . and S22, S24, . . . , and the left data signal L2 of the second image is supplied to the data lines D11 to D1m and D21 to D2m formed in the upper and lower units 132 and 134, corresponding to the scan signal. The second power source ELVSS is set to the low voltage during the second frame 2F′. Accordingly, the pixels 140 formed on the even-numbered horizontal lines emit light, corresponding to the left data signal L2 of the second image during the second frame 2F′.

During a third frame 3F′ of the second period T2′, a scan signal is progressively supplied to the even-numbered scan lines S12, S14, . . . and S22, S24, . . . , and the right data signal R2 of the second image is supplied to the data lines D11 to D1m and D21 to D2m formed in the upper and lower units 132 and 134, corresponding to the scan signal. Here, during the third frame 3F′, the pixels formed on the even-numbered horizontal lines store the left or right data signal L2 or R2 of the second image, corresponding to the positions thereof. Thus, the second power source ELVSS is set to the high voltage so that an undesired image is not displayed during the third frame 3F′.

During a fourth frame 4F′ of the second period T2′, a scan signal is progressively supplied to the even-numbered scan lines S12, S14, . . . and S22, S24, . . . , and the right data signal R2 of the second image is supplied to the data lines D11 to D1m and D21 to D2m formed in the upper and lower units 132 and 134, corresponding to the scan signal. The second power source ELVSS is set to the low voltage during the fourth frame 4F′. Accordingly, the pixels 140 formed on the even-numbered horizontal lines emit light, corresponding to the right data signal R2 of the second image during the fourth frame 4F′.

During a fifth frame 5F′ of the second period T2′, a scan signal is progressively supplied to the even-numbered scan lines S12, S14, . . . and S22, S24, . . . , and the black data signal is supplied to the data liens D11 to D1m and D21 to D2m formed in the upper and lower units 132 and 134, corresponding to the scan signal. Then, the black data signal is progressively supplied to the pixels 140 formed on the even-numbered horizontal lines.

Meanwhile, light is supplied to the left side of the second glasses in the first and second frames 1F′ and 2F′ of the second period T2′, and light is supplied to the right side of the second glasses in the third and fourth frames 3F′ and 4F′ of the second period T2′. Then, the viewer wearing the second glasses recognizes the second image as a 3D screen.

Additionally, in the disclosed technology, the pixels 140 emit light in only the second and fourth frames 2F′ and 4F′ among the consecutive five frames. Thus, the second image with a luminance lower than that to be implemented can be displayed. In the disclosed technology, in order to overcome such a disadvantage, the second power generation unit 170′ controls the low voltage of the second power source ELVSS so that an image of a desired gray scale (luminance) can be implemented during the second and fourth frames 2F′ and 4F′. In one exemplary implementation, the second power generation unit 170′ controls the low voltage of the second power source ELVSS to have a voltage lower than a generally supplied voltage, so that the desired luminance can be implemented corresponding to a data. Meanwhile, the pixels 140 of the disclosed technology are driven using the digital driving method, and accordingly, each frame 1F′ to 5F′ can be divided into a plurality of subfields so that a gray scale is implemented.

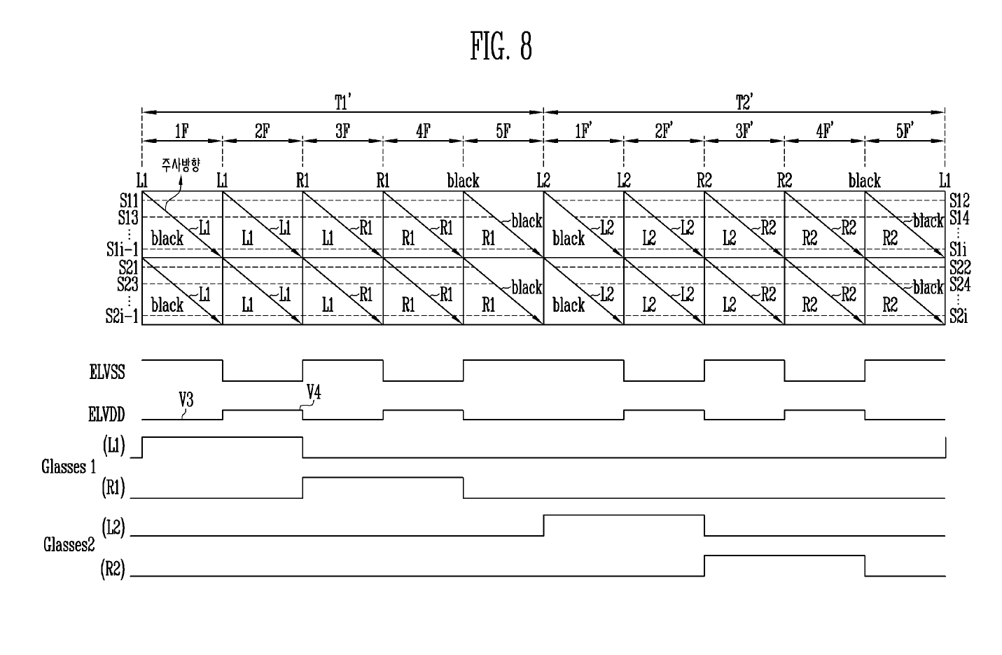

FIG. 8 is a diagram illustrating a driving method according to still another embodiment of the disclosed technology. In FIG. 8, detailed descriptions of portions identical to those of FIG. 7 will be omitted.

Referring to FIG. 8, in this embodiment, the voltage of the first power source ELVDD is controlled. Specifically, the first power generation unit 160′ supplies a first power source ELVDD of the third voltage V3 during the first frame 1F or 1F′, the third frame 3F or 3F′ and the fifth frame 5F or 5F′, in which the pixels 140 are set in the non-emission state, and supplies a first power source ELVDD of the fourth voltage V4 higher than the third voltage V3 during the second frame 2F or 2F′ and the fourth frame 4F or 4F′, in which the pixels 140 are set in the emission state.

Here, the third voltage V3 is set as a voltage at which the pixels 140 can generally emit light in the digital driving method. Thus, the pixels 140 can stably store the voltage of a desired data signal during the first frame 1F or 1F′, the third frame 3F or 3F′ and the fifth frame 5F or 5F′, in which the pixels 140 are set in the non-emission state. The fourth voltage V4 is set as a voltage higher than the third voltage V3.

If the fourth voltage V4 higher than the third voltage V3 is supplied during the second frame 2F or 2F′ and the fourth frame 4F or 4F′, in which the pixels 140 emit light, the luminance of the pixels 140 is improved.

In the disclosed technology, the organic light emitting diode OLED can generate red, green and blue light, corresponding to the amount of current supplied from the driving transistor, or can generate white light, corresponding to the amount of the current supplied from the driving transistor. In a case where the organic light emitting diode OLED generates white light, a color image is implemented using a separate color filter or the like.

By way of summation and review, an organic light emitting diode display includes a plurality of pixels arranged in a matrix form at intersection portions of data lines, scan lines and power lines. Each pixel generally includes an organic light emitting diode, two or more transistors including a driving transistor, and one or more capacitors.

In the organic light emitting diode display, in order to implement a 3D image, a left image is displayed in a first frame among consecutive four frames, and a right image is displayed in a third frame among the consecutive four frames. An image of black is displayed in second and fourth frames in which the left and right images are mixed.

In case of shutter glasses, light is supplied to the left side of the glasses during the first frame, and light is supplied to the right side of the glasses. In this case, a viewer wearing the glasses recognizes an image supplied through the glasses as a 3D screen.

However, a high driving frequency is required to implement a 3D image. Accordingly, a voltage corresponding to a data signal cannot be sufficiently charged in the pixel. Particularly, in a dual view method in which different viewers watches two different 3D images displayed in a display unit, a sufficient voltage is not charged in the pixel, and therefore, a desired image is not displayed.

In the organic light emitting diode display and the driving method thereof according to the disclosed technology, a scan signal is supplied the odd-numbered or even-numbered scan lines during frames, and hence it is possible to sufficiently secure a charging time of the pixels. Further, the luminance of the pixels can be improved by controlling the voltage(s) of the first power source and/or the second power source. Accordingly, it is possible to display an image of a desired gray scale.

Exemplary embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment can be used singly or in combination with features, characteristics, and/or elements described in connection with other embodiments unless otherwise specifically indicated. Accordingly, it will be understood by those of skill in the art that various changes in form and details can be made without departing from the spirit and scope of the disclosed technology as set forth in the following claims.

What is claimed is:

1. An organic light emitting diode (OLED) display, comprising:
a plurality of pixels;
a scan driver configured to supply a first scan signal to odd-numbered scan lines during a first period via a plurality of frames and to supply a second scan signal to even-numbered scan lines during a second period via a plurality of frames;
first and second power generation units configured to control the voltages of first and second power sources, respectively, so that the pixels are set in a non-emission state during at least one frame of the first and second periods; and
a data driver configured to supply a plurality of data signals to a plurality of data lines synchronous to the first and second scan signal, wherein current from the first power source to the second power source via an OLED of each of the pixels is set at least partially based on the data signal.

2. The OLED display of claim 1, wherein each of the first and second periods includes five frames.

3. The OLED display of claim 2, wherein the data driver is further configured to:
supply a left data signal of a first image during first and second frames of the first period,
supply a right data signal of the first image during third and fourth frames of the first period, and
supply a black data signal during a fifth frame of the first period, and
wherein the data driver is further configured to:
supply a left data signal of a second image during first and second frames of the second period,
supply a right data signal of the second image during third and fourth frames of the second period, and
supply a black data signal during a fifth frame of the second period.

4. The OLED display of claim 3, wherein light is supplied to the left side of first glasses during the first and second frames of the first period, and wherein light is supplied to the right side of the first glasses during the third and fourth frames of the first period.

5. The OLED display of claim 3, wherein light is supplied to the left side of second glasses during the first and second frames of the first period, and wherein light is supplied to the right side of the second glasses during the third and fourth frames of the second period.

6. The OLED display of claim 3, wherein the second power generation unit sets the second power source to have a high voltage so that the pixels do not emit light during the first, third and fifth frames of the first and second periods, and wherein the second power generation unit sets the second power source to have a low voltage so that the pixels emit light during the second and fourth frames of the first and second periods.

7. The OLED display of claim 6, wherein the second power generation unit sets the second power source to have the low voltage so that light of a desired luminance is generated to correspond to data of the second and fourth frames of the first and second periods.

8. The OLED display of claim 6,
wherein the first power generation unit is configured to generate the first power source,
wherein the first power generation unit sets the first power source to have a third voltage so that the pixels emit light during the first, third and fifth frames of the first and second periods, and
wherein the first power generation unit supplies a fourth voltage higher than the third voltage during the second and fourth frames of the first and second periods.

9. The OLED display of claim 1, wherein each frame of the first and second periods includes a plurality of subfields, and
wherein the scan driver supplies the first or second scan signal to the odd-numbered or even-numbered scan lines during every subfield, respectively.

10. The OLED display of claim 1, wherein the data driver supplies a first data signal when the pixels emit light, the first data signal corresponding to the scan signal, and wherein the data driver supplies a second data signal when the pixels do not emit light.

11. The OLED display of claim 1, wherein the first and second periods alternate with each other.

12. The OLED display of claim 1, wherein the display unit includes upper and lower units,
wherein the scan driver includes:
a first scan driver for driving scan lines formed in the upper unit, and
a second scan driver for driving scan lines formed in the lower unit, and
wherein the data driver includes:
a first data driver for driving data lines formed in the upper unit, and
a second driver for driving data lines formed in the lower unit.

13. The OLED display of claim 12, wherein the first and second scan drivers progressively supply the first or second scan signal to the odd-numbered or even-numbered scan lines, respectively.

14. A method of driving an organic light emitting diode (OLED) display, the method comprising:
supplying a first scan signal to odd-numbered scan lines via a plurality of frames during a first period;
supplying a first left or right data signal of a first image synchronized with the first scan signal;
supplying a second scan signal to even-numbered scan lines via a plurality of frames during a second period; and
supplying a second left or right data signal of a second image synchronized with the a second scan signal.

15. The method of claim 14, wherein the first and second periods alternate with each other.

16. The method of claim 14, wherein each of the first and second periods includes five frames.

17. The method of claim 14, wherein supplying the first left or right data signal comprises:
supplying the left data signal of the first image during first and second frames of the first period;
supplying the right data signal of the first image during third and fourth frames of the first period; and
supplying a first black data signal during a fifth frame of the first period, and
wherein supplying the second left or right data signal comprises:
supplying the left data signal of the second image during first and second frames of the second period;
supplying the right data signal of the second image during third and fourth frames of the second period; and
supplying a second black data signal during a fifth frame of the second period.

18. The method of claim 17 further comprising setting pixels of the OLED display in a non-emission state during the first, third and fifth frames of the first and second periods.

19. The method of claim 17 further comprising controlling, via pixels of the OLED display, whether current flowing from a first power source to a second power source via an OLED is supplied,
wherein the second power source is configured to be a high voltage during the first, third and fifth frames of the first and second periods.

20. The method of claim 19, wherein the first power source is set to a third voltage so that the pixels emit light during the first, third and fifth frames of the first and second periods, and
wherein the first power source is set to a fourth voltage higher than the third voltage during the second and fourth frames of the first and second periods.

21. The method of claim 17, wherein light is supplied to the left side of first glasses during the first and second frames of the first period, and wherein light is supplied to the right side of the first glasses during the third and fourth frames of the first period.

22. The method of claim 17, wherein light is supplied to the left side of second glasses during the first and second frames of the first period, and wherein light is supplied to the right side of the second glasses during the third and fourth frames of the second period.

23. The method of claim 14, wherein each frame of the first and second periods includes a plurality of subfields.

24. The method of claim 14, wherein the left and right data signals supplied during the first and second periods control the emission or non-emission of the pixels.
